(19) United States
(12) Patent Application Publication
(10) Pub. No.: US 2008/0251611 A1
(43) Pub. Date: Oct. 16, 2008

(54) Misting Apparatus

(75) Inventor: Gilles Delattre, Nice (FR)

Correspondence Address: YOUNG & THOMPSON, 209 Madison Street, Suite 500, ALEXANDRIA, VA, 22314, US

(73) Assignee: Delattre Indstrie Development, Nice (FR)

(21) Appl. No.: 12/088,694

(22) PCT Filed: Sep. 27, 2006
(86) PCT No.: PCT/EP06/66787

§ 371 Date: Mar. 31, 2008

(30) Foreign Application Priority Data
Oct. 5, 2005 (FR) 0553016

(51) Int. Cl. B05B 1/34; F04D 29/44

(52) U.S. Cl. 239/463; 415/208.1

(57) ABSTRACT

A humidifier (1) includes a gaseous flow-generating unit interacting with a unit for producing fluid droplets in such a way that a mist is formed. According to the invention, the gaseous flow-generating unit includes a centrifugal fan (2) which is provided with an input (5) oriented along the axis of rotation of the fan (2) and a radial output (6) for generating a radial droplet-transporting flow.

The present invention relates to a misting apparatus.

It will be used to generate mist in closed, semi or open spaces, such as terraces of houses, restaurants or industrial premises.

The device ensures cooling of the space by the absorption of heat during vaporization of the water mist.

Another use of the device is the diffusion of products (such as phytosanitary liquids, disinfectants, liquids for the treatment of smells, etc) in liquid form, in droplets, on a given space.

Document U.S. Pat. No. 6,786,701 reveals a grille-equipped helicoidal fan with nozzles diffusing water droplets in the front connected to a pressurised water supply circuit.

This type of fan only uses air at a low pressure, and this limits the range of the mist.

Moreover, the mist air returns towards the rear of the apparatus due to the depression that is created there.

This greatly reduces the performances of the device and leads to it operating in conditions of high humidity, which is detrimental to the reliability and the service life of the fan.

Documents US-A-2003/192482 and US-A-2004/065268 describe devices equipped with a helicoid fan similar to the previous one but enclosed in a hollow cylindrical body that reduces the return effect referred to previously.

That said, the shortcomings inherent in the design of these devices remain and in particular the following:
these devices only generate low air pressure and have poor misting range;
if it is required to increase the power of the fan in order to increase its range, there is a considerable increase in the noise generated;
these devices are extremely directional with the mist always dispatched in the axis of rotation of the fan.

The angular sector covered by the humidification and the inclination of projection have very limited adjustability.
the grille arranged on the front of the fan disturbs the flow and increases the noise generated by the assembly.

Patent US-A1-2002/0170309 is also known. This describes a portable device for the projection of water. Due to its technology, the droplets are too large to form a mist. Moreover, this device is extremely directional.

Documents NL-A-711 6 405 and FR-A-2 329 198 both describe two complicated systems for the ejection of droplets. They are extremely directional and generate large droplets.

Therefore there is a need to propose a misting apparatus that overcomes all or some of the disadvantages of the techniques known until now.

The present invention falls within this scope and proposes a misting apparatus that uses a centrifugal fan as the means generating an outgoing gaseous flow.

According to the invention, the input is oriented on the axis of rotation of the centrifugal fan and the output is radial.

The applicant has observed that the centrifugal fan installed in the misting apparatus achieves a pressure that is much higher than the pressure obtained by helicoid fans of equivalent power and diameter.

A deviation of 50 to 100% is observed.

Thus, the invention benefits from the available pressure in order to increase the range of the misting apparatus.

This pressure reserve also allows deflectors to be used so as to orient the flow in the required direction and to increase the output rate in order to further increase the range of humidification.

Deflectors cannot be used satisfactorily with a helicoidal fan as the air pressure generated is too low, with the result that the air flow would be too slow.

Another advantage of the invention in a preferred embodiment is that it allows humidification of a 360° sector without the need for a deflector.

The device benefits from the radial orientation of the flow generated by the fan.

Thus the surface treated by the humidification process is greatly increased over existing devices.

It is also noted that such a configuration causes limited noise nuisance to users insofar as the device can be placed above traffic zones and therefore above the head of users and insofar as the noise observed according to the invention is at less high frequencies than is the case on existing devices.

Due to the orientation of the output flow and the pressure of the centrifugal fan, the invention also avoids the loop phenomena observed on fans according to U.S. Pat. No. 6,786,701.

Whereas the state of the art systematically suggests the use of fans rotating around a roughly horizontal axis, the invention deviates from this principle by having a roughly vertical axis.

By acting in combination with the nozzles supplied by a pressurized water circuit, we observe that the invention generates a fine mist with excellent spatial distribution. This point is important in particular when the device is used as a cooler because it allows a high rate of evaporation.

Other goals and advantages will appear in the following description which describes a preferred embodiment of the invention but which is not restrictive.

First of all, it is recalled that the invention relates to a humidification device comprising a gaseous flow-generating unit coacting with means for the production of droplets of a liquid to form a mist, characterised in that the means for the generation of the gas flow consist of a centrifugal fan with an intake oriented on the fan's axis of rotation and a radial output to generate a radial flow transporting the droplets.

In an advantageous but non-exhaustive manner, this device is such that:
the means of droplet production consist of diffusing nozzles located downstream from the fan discharge and supplied by a pressurized water circuit.
the nozzles are situated in the radial flow.
the nozzles are situated above the radial flow.
the device has multiple vanes deflecting the gaseous flows and fitted to swivelling on an axis parallel to the axis of rotation of the centrifugal fan, possibly with means for actuating the deflection vanes.
the device has a series of guide vanes deflecting the gas flows and assembled so as to swivel on an axis orthogonal to the axis of rotation of the centrifugal fan, eventually with means for rotational actuation.
the device includes a body in which the centrifugal fan is assembled, communicating with an air inlet and comprising at least one radial output projecting the gaseous flow.
the body has a polygonal circumference, at least one side of which has an output.
the device comprises means for closing at least one output.
the body has a cylindrical circumference at least one angular sector of which has an output.
the axis of rotation of the centrifugal fan is vertical.
the device comprises a support leg with a pipe supplying the centrifugal fan.
the pipe constitutes the vertical part of the leg.

The attached drawings are given as examples and are not restrictive. They show only one embodiment of the invention and will allow the invention to be easily understood.

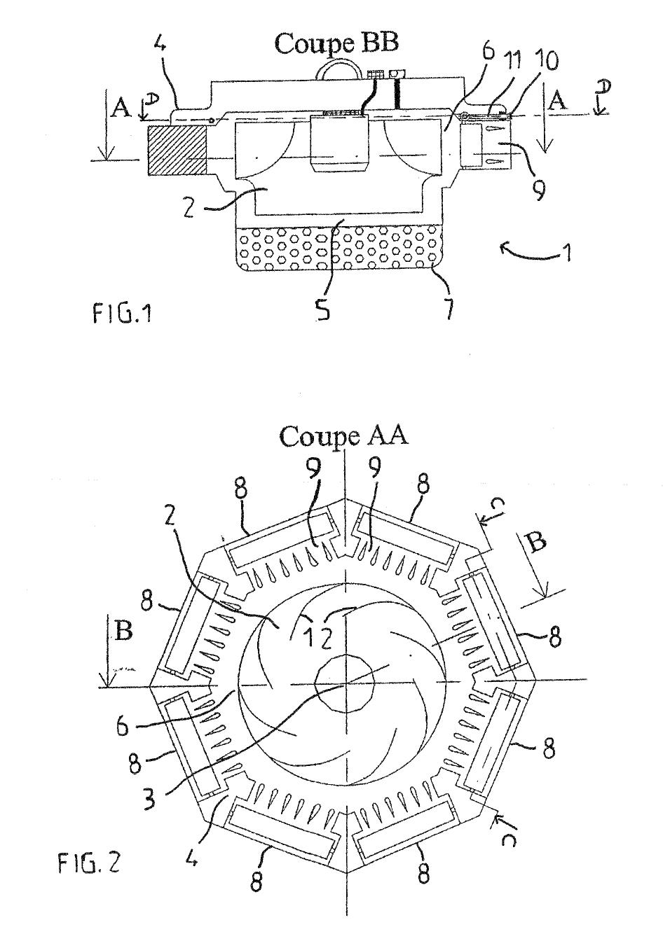

FIG. 1 is a longitudinal section of the invention device and FIG. 2 is a cross section.

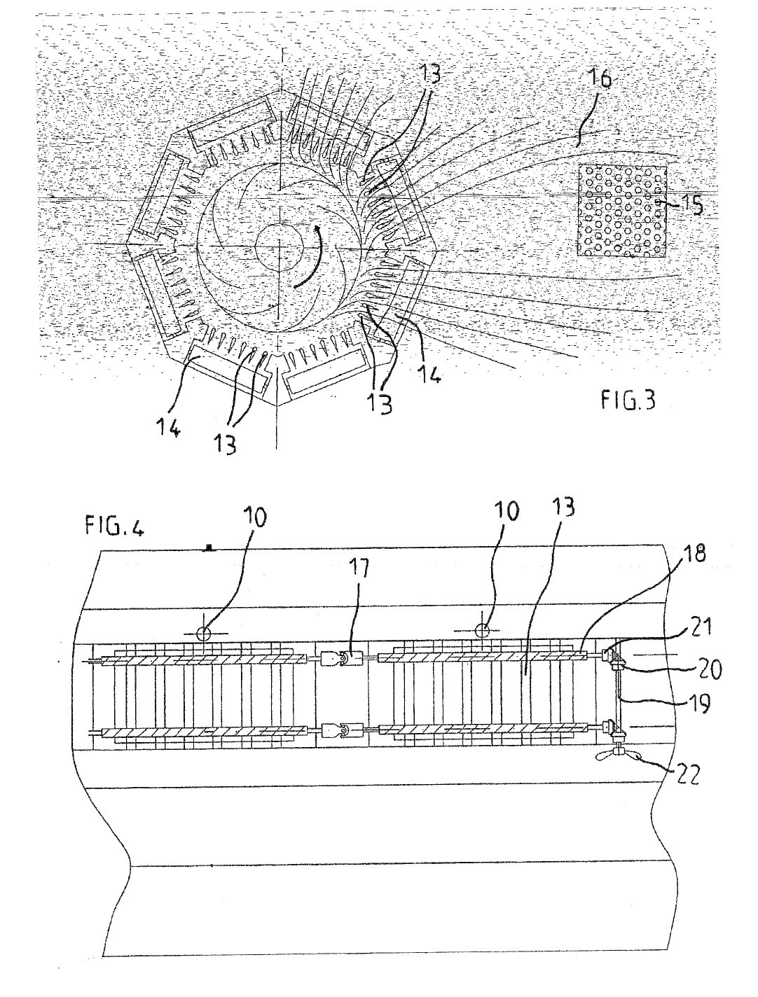

FIG. 3 shows the outgoing air flow and the possibilities of adjusting its orientation.

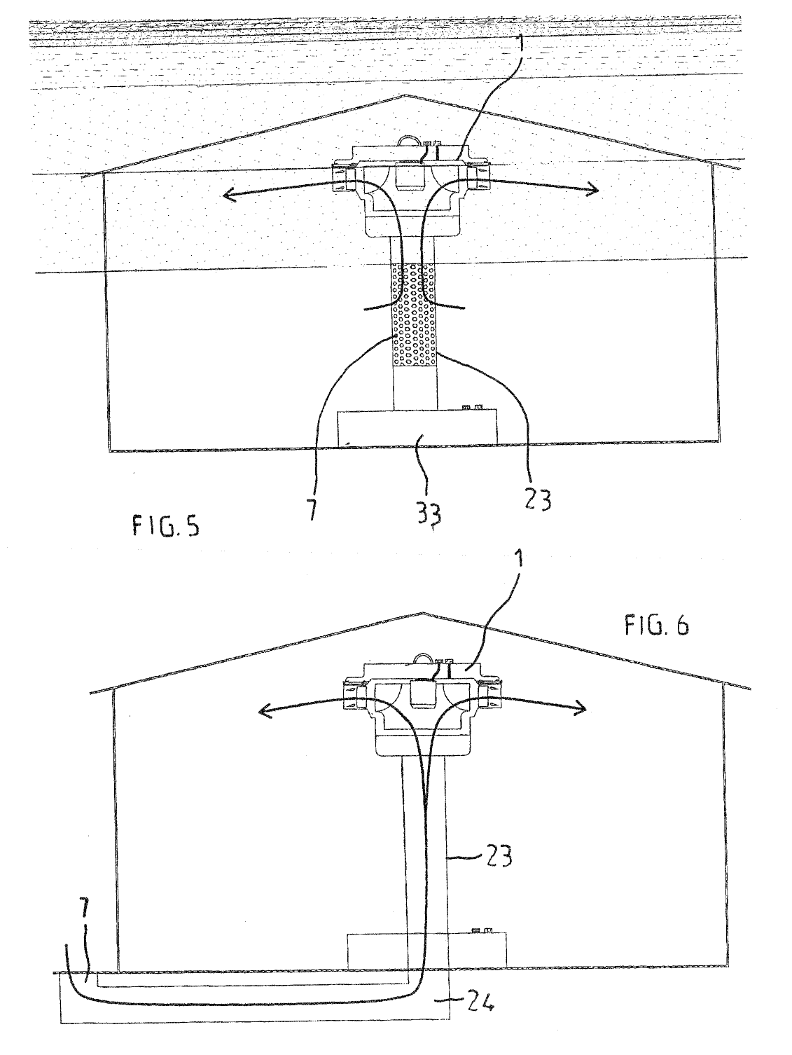

FIG. 4 is a section along line C-C on FIG. 2 showing an example of the means for actuating the deflectors.

FIG. 5 is an example of the invention positioned on a leg and FIG. 6 shows another example of the installation with an offset air intake.

FIG. 7 shows another possibility of installation by hanging the device at ceiling level.

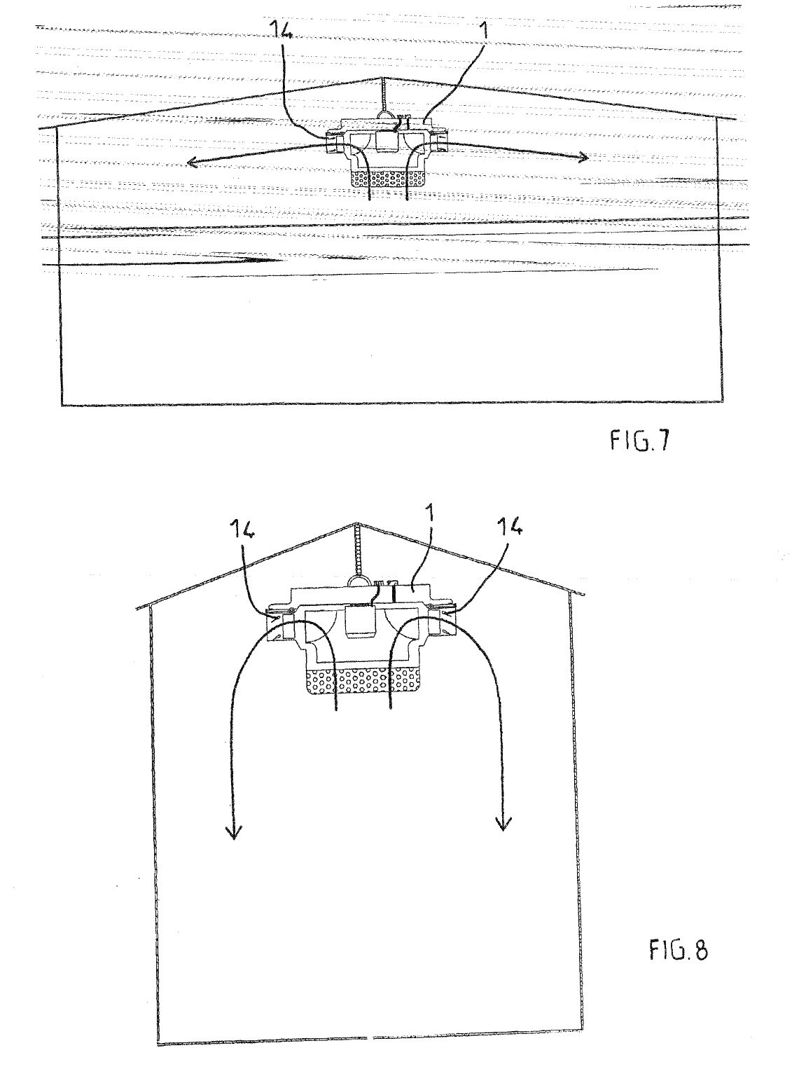

FIG. 8 shows an alternative method of hanging with adjustment of the deflectors so as to orient the flow differently.

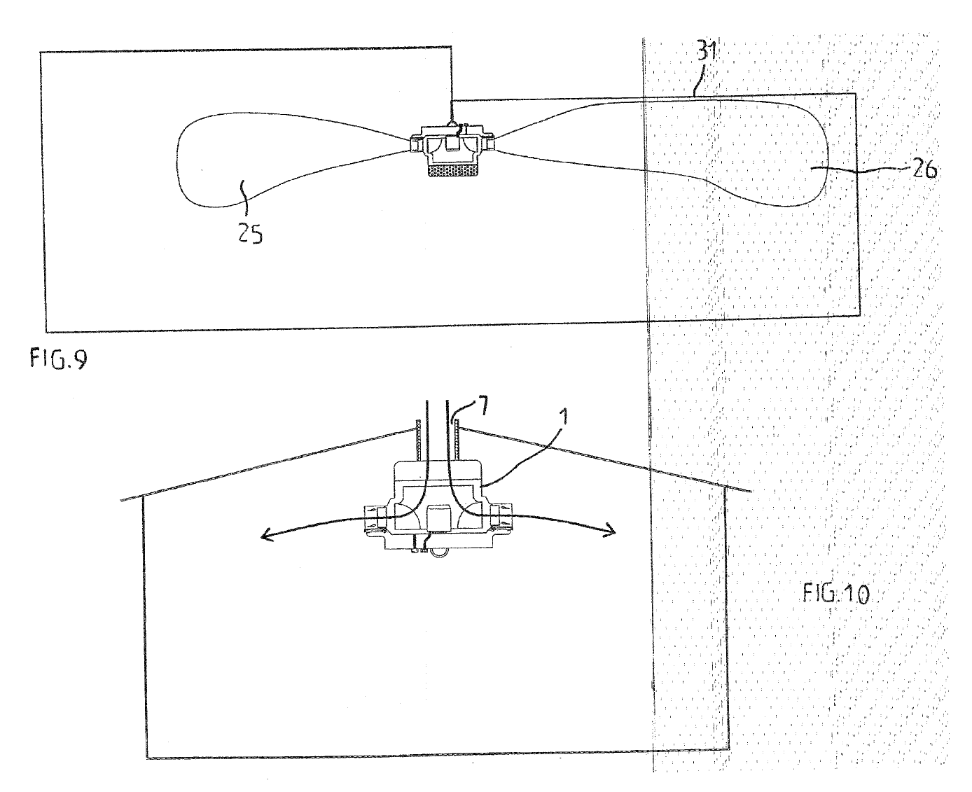

FIG. 9 schematises the possibilities of adjusting the height of flow projection relative to the walls so as to use or not a “Coanda” type effect.

FIG. 10 shows a method of creating an air intake through the top of the device.

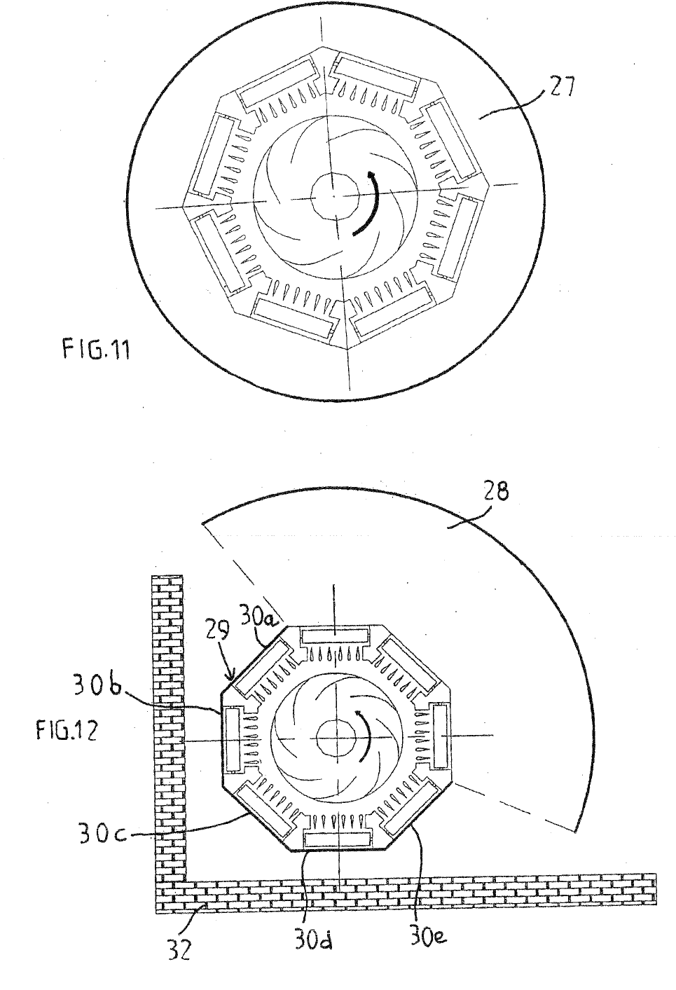

FIGS. 11 and 12 show two different adjustments of the projection sector of the radial air stream.

In FIG. 11, the projection is at 360° whereas the sector is smaller in FIG. 12 thereby allowing the configuration to be adapted to the premises.

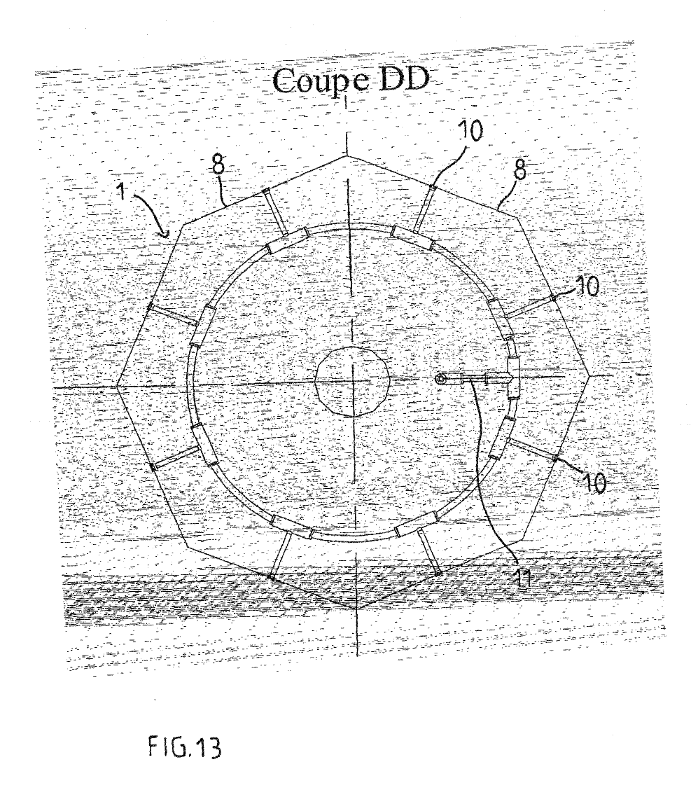

FIG. 13 is a top view of the device.

Below is an example of water droplet production, which is not restricted to usable liquids.

Similarly, the generation of an air flow is described, although other gaseous fluids can be used.

As can be seen in particular on FIGS. 1 and 2, device 1 of the invention is equipped with a centrifugal fan 2 formant means for generating an air flow with a radial discharge of air relative to the axis of rotation 3 of centrifugal fan 2.

In the example shown, centrifugal fan 2 is housed in a plastic or metal body 4 with a peripheral output for ejection of radial flow 16.

Centrifugal fan 2 has an input 5 which is arranged in communication with an input 7 located close to input 5 in the case of FIG. 1 but able to be offset as shown in the example of FIG. 6, or installed at mid-height in the case of FIG. 5.

Air intake 5 can be situated in the lower part of fan 2 or on its upper face as in FIG. 10.

Generally, but not in a restrictive manner, axis of rotation 3 is arranged vertically.

In this way, the radial flow generated is projected on a horizontal plane.

To execute the projection, discharge 6 of the fan, which is positioned on its circumference downstream of blades 12 of the centrifugal fan, is placed opposite to one or more projection discharges 9 formed in body 4 of device 1.

In the case described here and shown on FIG. 2, body 4 has a part with polygonal section defining multiple sectors 8, each one with an outlet 9.

The flow of air is thus ejected from device 1 through each outlet 9, the flow then covering a 360° sector.

It is also possible to close one or more discharges completely or partially so as to limit the angular surface covered by the projection.

FIG. 11 shows a 360° projection configuration whereas FIG. 12 shows a sector projection configuration restricted by using a screen 29 closing certain outlets 9.

In the example shown, screen 29 consists of multiple closing inlets 30a, b, c, d, e.

The configuration shown is of course not exhaustive.

In particular, a body 4 with partly circular section rather than polygonal and a screen that can cover all or part of the circular portion or the opening may be envisaged.

In a preferred arrangement, nozzles 10 connecting with the closed portion will be closed or replaced by plugs, or their supply circuit closed.

According to a first arrangement, the generation of water droplets takes place in the ejection zone of the radial air flow 16.

This ensures that the droplets are directly carried by the outgoing flow.

According to another arrangement, the droplets are generated slightly above the output of the air flow as shown on FIGS. 1 and 13.

On these figures, the means for producing the water droplets comprise multiple nozzles 10 of current design supplied with pressurized water via a supply circuit 11 drawing from a water tank or mains water and pumping and filtering means.

FIG. 13 shows supply circuit 11 with a peripheral part for the distribution of water at pressure towards nozzles 10.

In the example shown, nozzle 10 is formed for each sector 8.

It is an advantage to be able to offset the height of nozzles 10 relative to the radial air flow for certain applications as this arrangement increases the height of the layer of mist by more than 50%.

However, the range is generally decreased. By increasing the height of humidification, an impression of more uniform humidification is achieved and not a very directional jet.

Below are the test results carried out by the applicant in the form of a table with height h and width w of the cloud of mist obtained at a given distance from device 1 as well as the humidified surface at this distance relative to the offset in height (o) between nozzles 10 and the median axis of air discharge outlets 9.

Test conditions:

Ventilation: 200 m3/ h; discharge: 200 × 100 (mm)
1 standard nozzle DID Clim B01, 0.08 l/min at 50 bars
Operating pressure: 50 bars

Measurement distance: 2.50 m

| o (cm) | w (cm) | h (cm) | Covered area (m²) |
|---|---|---|---|
| 0 | 80 | 60 | 0.48 |
| 5 | 90 | 65 | 0.59 |
| 10 | 110 | 70 | 0.77 |
| 15 | 120 | 80 | 0.96 |

Measurement distance: 3.5 m

| o (cm) | w (cm) | h (cm) | Covered area (m²) |
|---|---|---|---|
| 0 | 100 | 80 | 0.80 |
| 5 | 115 | 80 | 0.92 |
| 10 | 130 | 80 | 1.04 |
| 15 | 140 | 90 | 1.26 |

| o (cm) | Range (m) |
|---|---|
| 0 | 5.90 |
| 5 | 5.60 |
| 10 | 4.90 |
| 15 | 4.50 |

The cloud of mist therefore has greater height and more generally covers a greater surface by offsetting the nozzles relative to the flow of outgoing air.

By this parallel arrangement of the means for generating the flow of air and the means for generating droplets of water, the resulting speed is roughly equivalent to that of centrifugal fan 2 and the total range changes little.

On the other hand, the resulting air flow is greater than that of the fan alone, which increases the total volume treated.

On the contrary, by placing in series the means for generating the flow of air and the means for generating the droplets, the resulting air speed is greater than that of the centrifugal fan alone thereby increasing the total range, whereas the resulting flow is roughly equivalent to the discharge from the centrifugal fan which explains why the volume treated is practically unchanged.

Account also has to be taken of the induction rate, which is the ratio of the total air flow over the primary flow and implies that the total volume of air moved is greater than the volume of primary air.

Consequently, the configuration of device 1 of the invention, which has a radial output, allows the position of nozzles 10 to be adjusted relative to the required application.

Depending on the applications, uniformity may be preferred when it is required to ensure equal cooling at all points on a treated area.

In other cases, it may be preferred to increase the range in order to cover a wider radius.

Means may be envisaged for altering the position of the nozzles relative to the projection outlets 9 so as to adjust to the needs of a particular application.

Nozzles 10 can also be positioned below outlets 9 if the application lends itself to this configuration.

In order to orient radial flow 16, deflection means are proposed at the level of projection outlets 9.

In the example shown, the deflection means have multiple vanes 13 whose axis is oriented parallel to the rotational axis of centrifugal fan 2 and multiple vanes 14 arranged to pivot on an axis which is orthogonal to axis 3 of fan 2.

It will be easily understood that the association of these two types of vanes 13, 14 allows the fine adjustment of the orientation of flow 16.

The example on FIG. 3 shows that an obstacle 15 situated at the periphery of device 1 can be avoided by orienting the vanes in an appropriate manner.

According to a first embodiment, vanes 13 or/and vanes 14 can be adjusted manually and individually.

Their movement can also be coupled in order to form series of vanes 13 and/or 14 swiveling simultaneously.

According to another embodiment, the movement of vanes 13 and/or 14 is driven by any current means.

FIG. 4 shows an example of the rotational drive of vanes 14.

When used in this context, vanes 14 are rotationally connected by drive rods 18 connected by universal joint 17 and driven by a series of bevel gears 20, 21 providing the angle drive for a rotational movement of axis 19 operated through handle 22, but which could be replaced by a motor.

The configuration thus shown is however not restrictive and any means for changing the position of vanes 13 or vanes 14 comes within the scope of the present invention.

It is easily understood that the association of deflection vanes 13, 14 with centrifugal fan 2 ensuring radial output of air flow 16 improves the possibilities of adjusting the outgoing flow.

FIGS. 7 and 8 are an illustration showing a different orientation of the flow to suit the configuration of the building.

FIG. 9 shows how the Coanda effect can be put to effect by positioning device 1 at a low ceiling height (wall 31).

This effect is characterized by a longer range of a flow when this is tangent to a wall.

A similar effect can be achieved by using vanes 14 so as to orient them upwards.

The Coanda effect allows the range of the humidified zone (zone 26) to be appreciably lengthened compared to use without the Coanda effect (zone 25).

There are several possibilities for positioning the humidification device 1. FIGS. 7, 8, 9 and 10 are an example of the device hanging from the ceiling of a building thereby avoiding any occupation of the floor.

FIG. 10 shows the formation of a stack in this context in order to arrange input 7 outside of the building.

FIGS. 5 and 6 show the use of a leg to form the vertical support of the fan in device 1.

In a favourable configuration, the leg is in the form of a pipe 23 with hollow tubular form (square or polygonal, cylindrical or other section) bringing air up to input 5 of centrifugal fan 2.

This allows input 7 to be created with multiple openings on the surface of the pipe as in FIG. 5 or further offset the air intake by using a pipe 24 suitable for example for connecting to the outside.

This latter case is shown in the configuration on FIG. 10 for renewing the air inside the building.

Base 33 is an appropriate stand for pipe 23 on the floor.

### REFERENCES

1. Misting apparatus
2. Centrifugal fan
3. Axis of rotation
4. Body
5. Input
6. Output
7. Air inlet
8. Sectors
9. Air outlet
10. Nozzles
11. Supply circuit
12. Blades
13. Axial vanes
14. Orthogonal vanes
15. Obstacle
16. Flow
17. Universal joint
18. Rod
19. Pin
20, 21. Bevel gears
22. Handle
23. Pipe
24. External pipe
25. Mist zone
26. Mist zone
27. Mist zone
28. Mist zone
29. Screen
30. a, b, c, d, e. Air intake
31. Wall
32. Wall
33. Base

1. Misting apparatus (1) comprising a gaseous flow-generating unit interacting with a unit for producing fluid droplets in such a way that a mist is formed, characterized in that
the gaseous flow generating unit consists of a centrifugal fan (2) which is provided with an input (5) oriented along the axis of rotation (3) of fan (2) the said axis being vertical and a radial output (6) to generate a radial droplet-transporting flow, and the means for producing the droplets comprising diffusion nozzles (10) situated downstream from output (6) of fan (2) and supplied from a pressurized water circuit.

2. Misting apparatus (1) according to claim 1 in which nozzles (10) are positioned in the radial flow.

3. Misting apparatus (1) according to claim 1 in which the nozzles (10) are situated above the radial flow.

4. Misting apparatus (1) according to claim 1, with multiple vanes (13) for deflecting the gaseous flows fitted to swivel on an axis parallel to the axis of rotation (3) of centrifugal fan (2).

5. Misting apparatus (1) according to claim 1 with multiple vanes (14) for deflecting the gaseous flow fitted to swivel on an orthogonal axis to the axis of rotation (3) of centrifugal fan (2).

6. Misting apparatus (1) according to claim 4 comprising means for actuating deflection vanes (13, 14).

7. Misting apparatus (1) according to claim 1, comprising a body (4) in which is fitted the centrifugal fan (2), connecting with an input (7) and comprising at least one gaseous flow radial projection outlet (9).

8. Misting apparatus (1) according to claim 7 in which body (4) has a polygonal circumference, at least one side of which has a projection output (9).

9. Misting apparatus (1) according to claim 7 in which body (4) has a cylindrical circumference at least one angular sector of which is equipped with a projection output (9).

10. Misting apparatus (1) according to claim 7 comprising means for closing at least one projection output (9).

11. Misting apparatus (1) according to claim 1 comprising one support leg with an air pipe (23) supplying the centrifugal fan (2).

12. Misting apparatus (1) according to claim 11 in which pipe (23) constitutes the vertical leg of the device.

13. Misting apparatus (1) according to claim 2, with multiple vanes (13) for deflecting the gaseous flows fitted to swivel on an axis parallel to the axis of rotation (3) of centrifugal fan (2).

14. Misting apparatus (1) according to claim 3, with multiple vanes (13) for deflecting the gaseous flows fitted to swivel on an axis parallel to the axis of rotation (3) of centrifugal fan (2).

15. Misting apparatus (1) according to claim 2 with multiple vanes (14) for deflecting the gaseous flow fitted to swivel on an orthogonal axis to the axis of rotation (3) of centrifugal fan (2).

16. Misting apparatus (1) according to claim 3 with multiple vanes (14) for deflecting the gaseous flow fitted to swivel on an orthogonal axis to the axis of rotation (3) of centrifugal fan (2).

17. Misting apparatus (1) according to claim 5 comprising means for actuating deflection vanes (13, 14).

18. Misting apparatus (1) according to claim 8 comprising means for closing at least one projection output (9).

19. Misting apparatus (1) according to claim 9 comprising means for closing at least one projection output (9).
